(19) United States
(12) Patent Application Publication
(10) Pub. No.: US 2023/0070498 A1
(43) Pub. Date: Mar. 9, 2023

(54) APPARATUS FOR GAZE ANALYSIS, SYSTEM AND METHOD FOR GAZE ANALYSIS OF USING THE SAME

(71) Applicant: VisualCamp Co., Ltd., Seoul (KR)

(72) Inventor: Yun Chan SUK, Seoul (KR)

(21) Appl. No.: 17/045,936

(22) PCT Filed: Oct. 30, 2019
(86) PCT No.: PCT/KR2019/014478

§ 371 Date: Oct. 7, 2020

(30) Foreign Application Priority Data
Oct. 23, 2019 (KR) 10-2019-0131915

(51) Int. Cl. G06Q 30/02; G06F 3/01

(52) U.S. Cl. CPC G06Q 30/0246; G06F 3/013

(57) ABSTRACT

An apparatus for gaze analysis according to an embodiment is for gaze analysis mounted on an apparatus including a display. The apparatus may include a gaze tracking unit that generates gaze tracking information by tracking a user's gaze with respect to content displayed on the display and a gaze analysis unit that detects fixation excluding saccade from the user's gaze, and generates gaze analysis information of the user on the content based on the detected fixation.

### TECHNICAL FIELD

Embodiments of the present invention relate to a gaze analysis technology.

### BACKGROUND ART

In recent years, as a penetration rate of mobile phones increases, the number of users who watch videos (movies, lectures, personal media content, etc.) using the mobile phones is increasing, and accordingly, from the point of view of an advertiser, there is a need for a way to effectively advertise through videos running on the mobile phones. In addition, the number of users (i.e., users who use online shopping malls) who shop using the mobile phones is increasing, and, from the point of view of an online shopping mall operator, there is a need for a way to effectively reflect the needs of users.

### DISCLOSURE OF THE INVENTION

### Technical Problem

A disclosed embodiment is to provide an apparatus for gaze analysis of a new technique, system and method for gaze analysis of using the same.

### Technical Solution

An apparatus for gaze analysis according to a disclosed embodiment is an apparatus for gaze analysis mounted on an apparatus including a display, and includes a gaze tracking unit that generates gaze tracking information by tracking a user's gaze with respect to content displayed on the display and a gaze analysis unit that detects Fixation excluding Saccade from the user's gaze, and generates gaze analysis information of the user on the content based on the detected fixation.

The gaze analysis unit may calculate fixation density in a preset region of interest for the content.

The gaze analysis unit may calculate one or more of the number of fixations per unit area, the number of fixations per unit time, and the number of fixations per unit time and per unit area from the content.

The apparatus for gaze analysis may further include a gaze analysis visualization unit that visualizes and displays one or more of the gaze tracking information and the gaze analysis information on the content.

The gaze analysis visualization unit may display the preset region of interest in the content with a first color, and change and display the preset region of interest with a second color different from the first color when the user's gaze according to the gaze tracking information is close to the region of interest or is positioned within the region of interest.

The gaze analysis visualization unit may display the user's gaze according to the gaze tracking information with a point on the content and differently display a size of the point in the content according to the gaze analysis information, and the gaze analysis information may include one or more of fixation density in the preset region of interest, the number of fixations per unit area, the number of fixations per unit time, and the number of fixations per unit time and per unit area.

A system for gaze analysis according a disclosed embodiment includes a user terminal that includes an apparatus for gaze analysis for generating gaze tracking information and gaze analysis information of a user on a shopping mall web page and a shopping mall web server that provides the shopping mall web page to the user terminal, receives one or more of the gaze tracking information and the gaze analysis information from the user terminal, and analyzes a degree of gaze concentration of the user on the shopping mall web page based on one or more of the gaze tracking information and the gaze analysis information.

The gaze analysis information may include one or more of fixation density for the shopping mall web page, fixation density for each preset region of the shopping mall web page, the number of fixations per unit area, the number of fixations per unit time, and the number of fixations per unit time and per unit area.

The shopping mall web server may include a web page providing module that provides the shopping mall web page to the user terminal and a data analysis module that calculates the degree of gaze concentration of the user on the shopping mall web page based on one or more of the gaze tracking information and the gaze analysis information.

The data analysis module may acquire user-related information including one or more of a user's age and a user's gender, and calculate an average degree of gaze concentration of one or more of the user's age and user's gender for each web page based on the user-related information and the gaze analysis information.

The data analysis module may extract a purchase decision factor of a user who purchases a product through the shopping mall web page based on gaze-related information of the corresponding user.

The data analysis module may check the degree of gaze concentration of the user by each region constituting a web page of the product purchased by the user in the web page, and extract a purchase decision factor of a user according to the degree of gaze concentration among regions constituting the web page.

The shopping mall web server may further include a user-customized module that changes one or more of an order and arrangement of respective regions of a web page to be provided to a corresponding user terminal according to the purchase decision factor of the user.

The data analysis module may calculate a purchase route pattern that includes one or more of the order of the web pages viewed by the user, a direction of the user's gaze flow within each web page, and a degree of gaze concentration for each region of each web page based on gaze-related information of the user who purchased the product through the shopping mall web page.

The data analysis module may select one or more of a product of interest, price range of interest, preferred color, and preferred brand of the user based on product-related information of products related to web pages whose degrees of gaze concentration are equal to or greater than a preset degree of gaze concentration among web pages viewed by the user based on the gaze-related information of the user.

The shopping mall web server may further include a user-customized module that extracts information about the previously stored product of interest, price range of interest, preferred color, and preferred brand of the corresponding user when being accessed by the user terminal, and recommends a product corresponding to the extracted information to the user.

A method for shopping mall gaze analysis according to a disclosed embodiment is a method performed in a computing device including one or more processors and a memory storing one or more programs executed by the one or more processors, the method for shopping mall gaze analysis including providing a shopping mall web page to a user terminal, receiving one or more of gaze tracking information and gaze analysis information from the user terminal, and analyzing a degree of gaze concentration of the user on the shopping mall web page based on one or more of the gaze tracking information and the gaze analysis information.

### Advantageous Effects

According to the disclosed embodiment, it is possible to more accurately check the attention and degree of concentration of the user on the content and a certain region of the content by analyzing the fixation density, the number of fixations per unit area, the number of fixations per unit time, and the number of fixations per unit time and per unit area of the user for the content displayed on the display.

In addition, it is possible to provide a customized service for each user by analyzing the user's gaze on the shopping mall web page is analyzed. In particular, it is possible to plan advertisements and products to lead to purchase again by grasping the purchase route pattern and purchase decision factor for each user.

### BRIEF DESCRIPTION OF THE DRAWINGS

FIG. 1 is a diagram illustrating a configuration of an apparatus for gaze analysis according to an embodiment of the present invention.

FIG. 2 is a diagram for illustrating that a gaze analysis unit calculates fixation density in a region of interest in a disclosed embodiment.

FIG. 3 is a diagram for illustrating that the gaze analysis unit calculates the number of fixations per unit area in the disclosed embodiment.

FIG. 4 is a diagram for illustrating that the gaze analysis unit calculates the fixation density for each region of the content in the disclosed embodiment.

FIG. 5 is a view illustrating an example in which a gaze analysis visualization unit visualizes and displays gaze tracking information in the content in the disclosed embodiment.

FIG. 6 is a view illustrating an example in which the gaze analysis visualization unit visualizes and displays gaze tracking information and gaze analysis information in the content in the disclosed embodiment.

FIG. 7 is a diagram illustrating a configuration of a shopping mall system for gaze analysis using the apparatus for apparatus for gaze analysis according to the embodiment of the present invention.

FIG. 8 is a block diagram illustrating a configuration of a shopping mall web server according to the embodiment of the present invention.

FIG. 9 is a block diagram for illustratively describing a computing environment including a computing device suitable for use in exemplary embodiments.

### MODE FOR CARRYING OUT THE INVENTION

Hereinafter, specific embodiments of the present invention will be described with reference to the accompanying drawings. The following detailed description is provided to aid in a comprehensive understanding of a method, a device and/or a system described in the present specification. However, the detailed description is only for illustrative purpose and the present invention is not limited thereto.

In describing the embodiments of the present invention, when it is determined that a detailed description of known technology related to the present invention may unnecessarily obscure the gist of the present invention, the detailed description thereof will be omitted. In addition, terms to be described later are terms defined in consideration of functions in the present invention, which may vary depending on intention or custom of a user or operator. Therefore, the definition of these terms should be made based on the content throughout this specification. The terms used in the detailed description are only for describing the embodiments of the present invention and should not be used in a limiting sense. Unless expressly used otherwise, a singular form includes a plural form. In this description, expressions such as “including” or “comprising” are intended to indicate any property, number, step, element, and some or combinations thereof, and such expressions should not be interpreted to exclude the presence or possibility of one or more other properties, numbers, steps, elements other than those described, and some or combinations thereof.

In the following description, terms such as “transmission”, “communication”, “sending”, “reception” of a signal or information, or other terms having similar meanings to these terms include not only a meaning that a signal or information is directly sent from one component to another component, but also a meaning that a signal or information is sent via another component. In particular, “transmitting” or “sending” a signal or information to one component indicates that the signal or information is “transmitted” or “sent” to the final destination of the signal or information, and does not mean that the component is a direct destination of the signal or information. The same is true for the “reception” of a signal or information. Also, in this specification, the fact that two or more pieces of data or information are “related” to each other means that when one piece of data (or information) may be acquired, at least a part of pieces of other data (or information) may be acquired based on the acquired data (information).

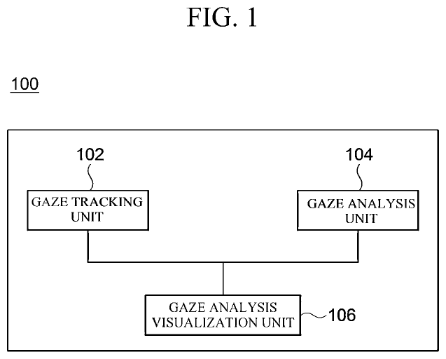

FIG. 1 is a diagram illustrating a configuration of an apparatus for gaze analysis according to an embodiment of the present invention

Referring to FIG. 1, an apparatus for gaze analysis 100 may include a gaze tracking unit 102, a gaze analysis unit 104, and a gaze analysis visualization unit 106.

In an exemplary embodiment, the apparatus for gaze analysis 100 may be provided on a user's smart device (e.g., a smart phone or a tablet PC) 50, but is not limited thereto. That is, it goes without saying that the apparatus for gaze analysis 100 may be provided in various digital devices including displays in addition to the smart device 50.

In addition, in one embodiment, the gaze tracking unit 102, the gaze analysis unit 104, and the gaze analysis visualization unit 106 may be implemented using one or more physically separated devices, or may be implemented by one or more processors or a combination of one or more processors and software, and may not be clearly distinguished in a specific operation unlike the illustrated example.

The gaze tracking unit 102 may track a user's gaze with respect to the content displayed on a display 60 of a smart device 50. Here, the content displayed on the display 60 may be a video (movie, personally produced video (e.g., YouTube video), lecture, sports video, news, drama, speech video, etc.), but is not limited thereto and may include an image, a web page, etc. The gaze tracking unit 102 may track the user's gaze on the display 60 on which the content is displayed.

The gaze analysis unit 104 may detect fixation excluding saccade from the tracked user's gaze. Here, the saccade is an eye movement in which both eyes move rapidly in the same direction at the same time, which occurs between fixations, and generally lasts 20 to 40 ms. The saccade is mainly used to direct a gaze toward an object of interest. In addition, the fixation means that the gaze is maintained at a single position, and may mean that the gaze is fixed. The fixation may generally last 50 to 600 ms.

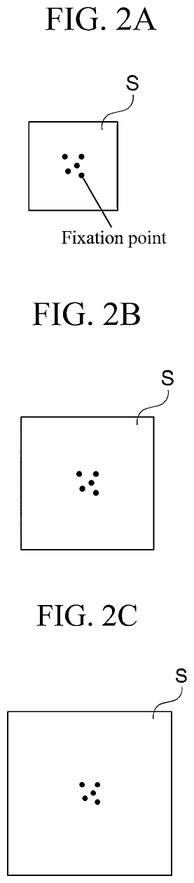

The gaze analysis unit 104 may calculate fixation density in a preset region of interest in the content displayed on the display 60. FIG. 2 is a diagram for illustrating that the gaze analysis unit 104 calculates the fixation density in the region of interest in the disclosed embodiment.

Referring to FIG. 2A, when an area of the region of interest (S) is 20×20 pixels and the number of fixations is five, the fixation density is 5/(20×20)=0.0125.

Referring to FIG. 2B, when the area of the region of interest (S) is 30×30 pixels and the number of fixations is five, the fixation density is 5/(30×30)=0.00555.

Referring to FIG. 2C, when the area of the region of interest (S) is 40×40 pixels and the number of fixations is five, the fixation density is 5/(40×40)=0.00315.

The number of fixations is all five in FIGS. 2A to 2C, but it can be seen that the fixation density is the highest in FIG. 2A.

For example, when a video is displayed on the display 60, the gaze analysis unit 104 may check which portion the degree of gaze concentration of the user is high by respectively calculating the fixation density by region of interest.

Herein, although it has been described that the fixation density is calculated for the preset region of interest, but is not limited thereto, and the fixation density may be calculated for the entire region.

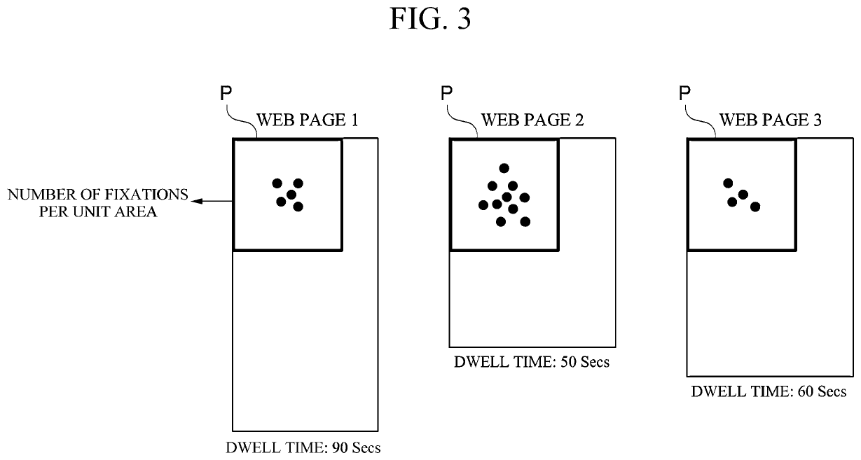

In addition, the gaze analysis unit 104 may calculate the number of fixations per unit area from the content displayed on the display 60. FIG. 3 is a diagram for illustrating that the gaze analysis unit 104 calculates the number of fixations per unit area in the disclosed embodiment.

Referring to FIG. 3, the content displayed on the display 60 may be a web page. Here, a case where a user views a web page 1, a web page 2, and a web page 3 will be described. The web page 1, web page 2, and web page 3 may have different sizes (areas).

The gaze analysis unit 104 may calculate the number of fixations for each web page 1, web page 2, and web page 3 by preset unit area (P). Here, the web page 1 corresponds to a case where five fixations are detected within a preset unit area (P), the web page 2 corresponds to a case where ten fixations are detected within the preset unit area (P), and the web page 3 corresponds to a case where four fixations are detected within the preset unit area (P). In this case, it can be confirmed that the number of fixations per unit area is in the order of the web page 2>the web page 1>the web page 3.

In addition, the gaze analysis unit 104 may calculate the number of fixations per unit time and per unit area from the content displayed on the display 60. For example, a case where the dwell time on the web page 1 is 90 seconds, the dwell time on the web page 2 is 50 seconds, and the dwell time on the web page 3 is 60 seconds will be described. Then, it can be seen that the number of fixations per unit time and per unit area is in the order of web page 2>web page 3>web page 1.

Meanwhile, the gaze analysis unit 104 may calculate the fixation density per unit time for the content displayed on the display 60. That is, the fixation density per unit time may be calculated for the entire region of the content. In this case, it is possible to check the degree of gaze concentration of the user compared to the total time during which the content is displayed on the display 60. For example, if the content is a video lecture, it is possible to check whether or not the user has watched the video lecture by how much concentration during the video lecture time.

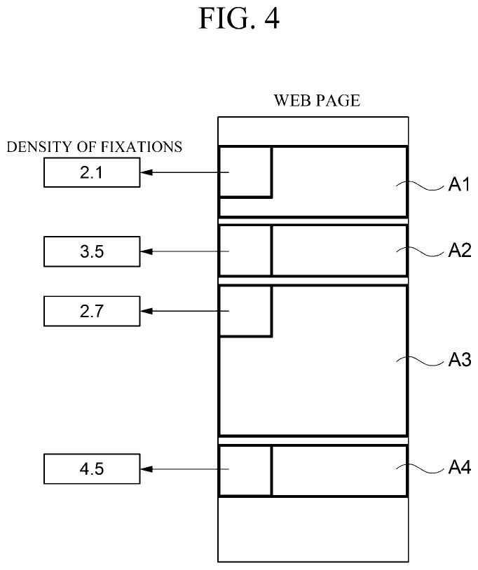

In addition, the gaze analysis unit 104 may calculate the fixation density by each region of the content displayed on the display 60. FIG. 4 is a diagram for illustrating that the gaze analysis unit 104 calculates the fixation density for each region of the content in the disclosed embodiment.

Referring to FIG. 4, the content displayed on the display 60 may be a web page of a shopping mall. Here, the web page may be divided into a main image region A1, a product information region A2, a detailed product image region A3, and a review region A4.

The gaze analysis unit 104 may calculate densities of fixations for the main image region A1, the product information region A2, the product detail image region A3, and the review region A4, respectively. In this case, the gaze analysis unit 104 may calculate the fixation density by dividing the number of fixations detected for each region by an area of the corresponding region.

For example, when the fixation density in the main image region A1 is 2.1, the fixation density in the product information region A2 is 3.5, the fixation density in the product detail image region A3 is 2.7, the fixation density in the review region A4 is 4.5, the user can see that the degree of gaze concentration on the review region A4 is the highest in the web page.

The gaze analysis visualization unit 106 may visualize and display gaze tracking information tracked by the gaze tracking unit 102 and gaze analysis information (e.g., the fixation density, the number of fixations per unit area, the number of fixations per unit time and per unit area, the number of fixations per unit time, etc.) analyzed by the gaze analysis unit 104 on the content.

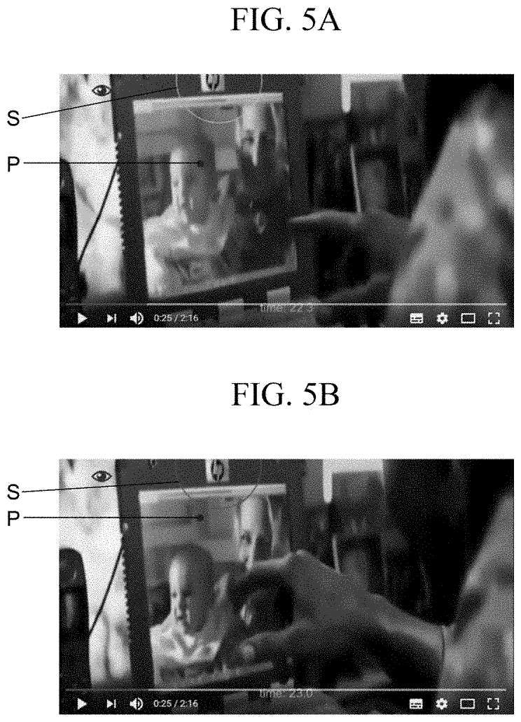

FIG. 5 is a view illustrating an example in which the gaze analysis visualization unit 106 visualizes and displays gaze tracking information in the content in one disclosed embodiment.

Referring to FIG. 5A, the gaze analysis visualization unit 106 may display the region of interest S (e.g., a region indicated by a PPL advertisement) (S) in the content displayed on the display 60 in a first color (e.g., green). In addition, the gaze analysis visualization unit 106 may display a user's gaze position P as a point in the content (displayed by a blue dot in FIG. 5).

Referring to FIG. 5B, when the user's gaze position P is close to the region of interest S (approaching within a preset distance), the gaze analysis visualization unit 106 may convert the region of interest S into a second color (e.g., red) and display the region of interest S.

However, the present invention is not limited thereto, and the color of the region of interest S may be changed when the user's gaze position P is positioned within the region of interest S. Here, when the user's gaze position P is positioned within the region of interest S, the gaze analysis unit 104 may calculate the fixation density, etc. in the region of interest S.

Through this, the PPL advertiser may check whether or not the corresponding user has viewed the PPL advertisement in the content, and may obtain information about the degree of concentration of the user on the PPL advertisement.

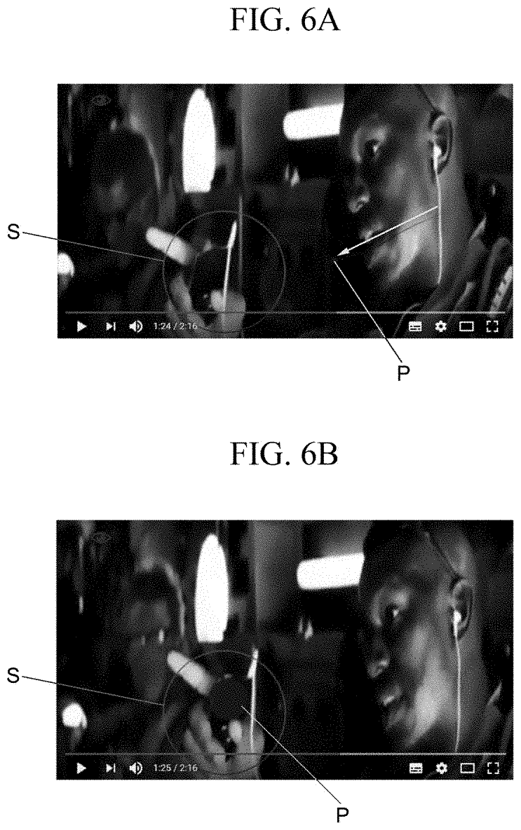

FIG. 6 is a diagram illustrating an example in which the gaze analysis visualization unit 106 visualizes and displays gaze tracking information and gaze analysis information in the content in a disclosed embodiment.

Referring to FIG. 6A, the gaze analysis visualization unit 106 may display a flow of the user's gaze position (P) on the content. Accordingly, it is possible to know in which direction the user's gaze position P moves in the content over time. Here, as the user's gaze position (P) is approaching the region of interest (S), the gaze analysis visualization unit 106 changes and displays the region of interest (S) with a second color (e.g., red).

Referring to FIG. 6B, when the user's gaze position (P) is positioned within the region of interest (S), the gaze analysis unit 104 may calculate the fixation density, etc. in the region of interest (S). In addition, the gaze analysis visualization unit 106 may display a point of the user's gaze position P larger as the fixation density, etc. increase. Here, the gaze analysis unit 104 may calculate the fixation density in the entire region of the content, not the region of interest (S), and may adjust and display a size of the gaze position P according to the fixation density.

Meanwhile, the gaze analysis visualization unit 106 may be provided in an external device different from the apparatus for gaze analysis 100. That is, when the apparatus for gaze analysis 100 transmits gaze tracking information and gaze analysis information to an external device, the external device (e.g., a server computing device or a terminal of a PPL advertiser) may visualize the gaze tracking information and gaze analysis information in the content.

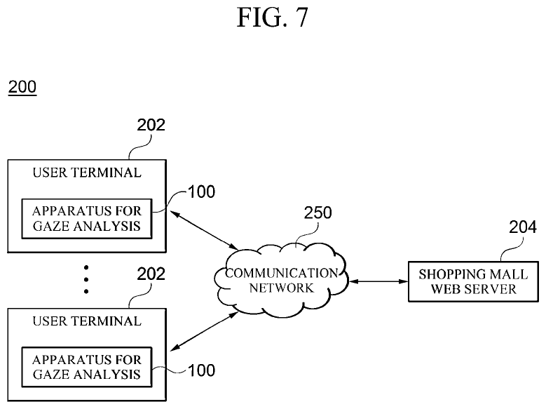

FIG. 7 is a diagram illustrating a configuration of a shopping mall system for gaze analysis using the apparatus for gaze analysis according to the embodiment of the present invention.

Referring to FIG. 7, a shopping mall system for gaze analysis 200 may include a user terminal 202 and a shopping mall web server 204.

Each user terminal 202 is communicably connected to the shopping mall web server 204 through a communication network 250. In some embodiments, the communication network 250 may include the Internet, one or more local area networks, wide area networks, cellular networks, mobile networks, other types of networks, or combinations of these networks.

The user terminal 202 may be a terminal of a user who uses an online shopping mall. In an exemplary embodiment, the user terminal 202 may be a mobile terminal such as a smart phone or a tablet PC, but is not limited thereto, and may include a notebook or a desktop PC. In the user terminal 202, the apparatus for gaze analysis 100 of the embodiment illustrated in FIG. 1 may be included.

The user terminal 202 may access the shopping mall web server 204 to receive a shopping mall web page. Then, the apparatus for gaze analysis 100 installed in the user terminal 202 may generate gaze tracking information and gaze analysis information of the user for shopping mall web page.

The user terminal 202 may transmit gaze-related information including one or more of gaze tracking information and gaze analysis information for the shopping mall web page to the shopping mall web server 204. In addition, the user terminal 202 may transmit user-related information (e.g., user ID, user's age, user's gender, etc.) to the shopping mall web server 204.

The shopping mall web server 204 may provide a shopping mall web page (e.g., a main page, a product detail page, etc.) to each user terminal 202. The shopping mall web server 204 may analyze a degree of gaze concentration of the on the shopping mall web page based on gaze-related information and user-related information received from each user terminal 202. The shopping mall web server 204 may provide a customized service for each user or extract a purchase decision factor for each user based on analyzed information.

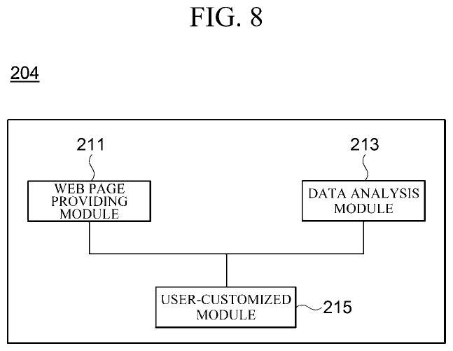

FIG. 8 is a block diagram illustrating a configuration of the shopping mall web server 204 according to an embodiment of the present invention. Referring to FIG. 8, the shopping mall web server 204 may include a web page providing module 211, a data analysis module 213, and a user-customized module 215.

The web page providing module 211 may provide the shopping mall web page (e.g., a main page, a product detail page, etc.) to each user terminal 202 accessing the shopping mall web server 204.

The data analysis module 213 may collect gaze-related information from each user terminal 202. In addition, the data analysis module 213 may collect user-related information from each user terminal 202. However, the present invention is not limited thereto, and the user-related information may be obtained during a login process.

The data analysis module 213 may calculate the degree of gaze concentration (e.g., the fixation density, the number of fixations per unit area, the number of fixations per unit time and per unit area, the number of fixations per unit time, etc.) for each web page based on the gaze-related information and user-related information collected from each user terminal 202.

Specifically, the data analysis module 213 may calculate an average degree of gaze concentration of each web page by user's age group. That is, the average degree of gaze concentration of each web page may be calculated using the gaze-related information of users of the same age group through the user-related information. In addition, the data analysis module 213 may calculate the average degree of gaze concentration of each web page for each user's gender. Through this, it is possible to calculate the average degree of gaze concentration for each user's age group and user's gender by each product category of the shopping mall.

The data analysis module 213 may extract gaze-related information of a user who has purchased a product in a shopping mall for the corresponding user, and extract a purchase decision factor of the corresponding user based on the extracted gaze-related information. Specifically, the data analysis module 213 may check the degree of gaze concentration of the user by each region on the web page of the product purchased by the corresponding user and extract the purchase decision factor of the corresponding user based on this the degree of gaze concentration of the user.

For example, it is assumed that a web page of a product purchased by a corresponding user consists of a main image region, a price and benefit information region, a product detail information region, a review region, and an exchange refund region, etc. For this, if the fixation density of the corresponding user is 2.5 in the main image region, 5.6 in the price and benefit information region, 3.9 in the product detail information region, 3.8 in the review region, and 2.2 in the exchange refund region, the purchase decision factor of the corresponding user may be extracted as the price and benefit information region with the highest gaze concentration.

In addition, the data analysis module 213 may extract the gaze-related information of the corresponding user for a user who has purchased a product in the shopping mall, and calculate a purchase route pattern of the corresponding user based on the extracted gaze-related information. That is, the user's purchase route pattern may be calculated by checking which web pages the user went through in the shopping mall until the user purchases the product (or puts the product in the shopping cart), the direction of the user's gaze flow in each web page, and the degree of gaze concentration on each web page. That is, the purchase route pattern may include an order of web pages viewed by a user, a direction of a user's gaze flow within each web page, and a degree of gaze concentration for each region of each web page.

In addition, the data analysis module 213 may check the user's product of interest, the user's price range of interest, the user's preferred color, the user's preferred brand, etc. based on the gaze-related information of the user. That is, the data analysis module 213 may select a product related to web pages having a high gaze concentration (e.g., the degree of gaze concentration is higher than or equal to a degree of a preset gaze concentration) among web pages viewed by a corresponding user as a product of interest of the corresponding user based on the gaze-related information of the user. In addition, the data analysis module 213 may select the price, color, and brand of the product related to web pages having a high gaze concentration among web pages viewed by the user based on the gaze-related information of the user as a price range of interest, preferred color, and preferred brand of the corresponding user.

The user-customized module 215 may provide a customized service according to the analysis result of the data analysis module 213. Specifically, the user-customized module 215 may check the purchase decision factor of each user and change a configuration of a web page to be provided to the user terminal 202 of the corresponding user according to the purchase decision factor. For example, when the user's purchase decision factor corresponds to a review region of the web page, the order of the review region in the web page to be provided to the user terminal 202 may be changed to follow the main image area.

In addition, the user-customized module 215 may change the configuration of the web page to be provided to the corresponding user terminal 202 based on the purchase decision factor and the product of interest of each user. For example, when the user's purchase decision factor is the price and benefit information and the user terminal 202 accesses the shopping mall web server 204 while an event is conducted for the product of interest of the corresponding user, the event of the corresponding product of interest may be displayed and provided on the main web page.

In addition, when the user terminal 202 accesses the shopping mall web server 204, the user-customized module 215 may extract previously stored information on the product of interest, information on the price range of interest, information on the preferred color, and information on the preferred brand of the user. In addition, the user-customized module 215 may recommend a product to the user according to one or more of information on the product of interest, information on the price range of interest, information on the preferred color, and information on the preferred brand of the user.

Here, the data analysis module 213 may be implemented in a separate server other than the shopping mall web server 204. In this case, the separate server may transfer analyzed information to the shopping mall web server 204.

In the present specification, the term “module” may mean a functional and structural combination of hardware for performing the technical idea of the present invention and software for driving the hardware. For example, the “module” may mean a logical unit of a predetermined code and hardware resources for executing the predetermined code, and does not necessarily mean a code that is physically connected or a single type of hardware.

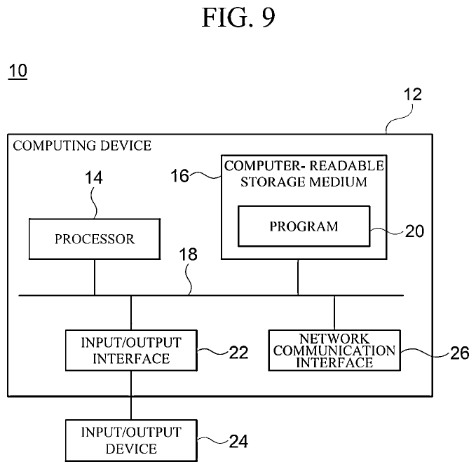

FIG. 9 is a block diagram illustrating and exemplifying a computing environment 10 that includes a computing device suitable for use in the exemplary embodiment. In the illustrated embodiment, each component may have different functions and capabilities in addition to those described below, and additional components may be included in addition to those described below.

The illustrated computing environment 10 includes a computing device 12. In an embodiment, the computing device 12 may be the apparatus for gaze analysis 100. In addition, the computing device 12 may be the user terminal 202. In addition, the computing device 12 may be the shopping mall web server 204.

The computing device 12 includes at least one processor 14, a computer-readable storage medium 16, and a communication bus 18. The processor 14 may cause the computing device 12 to be operated according to the exemplary embodiment described above. For example, the processor 14 may execute one or more programs stored on the computer-readable storage medium 16. The one or more programs may include one or more computer-executable instructions, which, when executed by the processor 14, may be configured to cause the computing device 12 to perform operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and can store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a voice or sound input device, input devices such as various types of sensor devices and/or photographing devices, and/or output devices such as a display device, a printer, a speaker, and/or a network card. The exemplary input/output device 24 may be included inside the computing device 12 as a component constituting the computing device 12, or may be connected to the computing device 12 as a separate device distinct from the computing device 12.

Although the representative embodiments of the present invention have been described in detail as above, those skilled in the art to which the present invention pertains will understand that various modifications may be made thereto within the limit that do not depart from the scope of the present invention. Therefore, the scope of rights of the present invention should not be limited to the described embodiments, but should be defined not only by claims set forth below but also by equivalents of the claims.

1: An apparatus for gaze analysis mounted on an apparatus comprising a display, comprising:
a gaze tracking unit that generates gaze tracking information by tracking a user's gaze with respect to content displayed on the display; and
a gaze analysis unit that detects fixation excluding saccade from the user's gaze, and generates gaze analysis information of the user on the content based on the detected fixation.

2: The apparatus of claim 1, wherein the gaze analysis unit calculates fixation density in a preset region of interest for the content.

3: The apparatus of claim 1, wherein the gaze analysis unit calculates one or more of the number of fixations per unit area, the number of fixations per unit time, and the number of fixations per unit time and per unit area from the content.

4: The apparatus of claim 1, further comprising:
a gaze analysis visualization unit that visualizes and displays one or more of the gaze tracking information and the gaze analysis information on the content.

5: The apparatus of claim 4, wherein the gaze analysis visualization unit displays the preset region of interest in the content with a first color, and change and display the preset region of interest with a second color different from the first color when the user's gaze according to the gaze tracking information is close to the region of interest or is positioned within the region of interest.

6: The apparatus of claim 4, wherein the gaze analysis visualization unit displays the user's gaze according to the gaze tracking information with a point on the content and differently display a size of the point in the content according to the gaze analysis information; and
the gaze analysis information comprises one or more of fixation density in the preset region of interest, the number of fixations per unit area, the number of fixations per unit time, and the number of fixations per unit time and per unit area.

7: A system for gaze analysis comprising:
a user terminal that comprises an apparatus for gaze analysis for generating gaze tracking information and gaze analysis information of a user on a shopping mall web page; and
a shopping mall web server that provides the shopping mall web page to the user terminal, receives one or more of the gaze tracking information and the gaze analysis information from the user terminal, and analyzes a degree of gaze concentration of the user on the shopping mall web page based on one or more of the gaze tracking information and the gaze analysis information.

8: The system of claim 7, wherein the gaze analysis information comprises one or more of fixation density for the shopping mall web page, fixation density for each preset region of the shopping mall web page, the number of fixations per unit area, the number of fixations per unit time, and the number of fixations per unit time and per unit area.

9: The system of claim 8, wherein the shopping mall web server comprises:
a web page providing module that provides the shopping mall web page to the user terminal; and
a data analysis module that calculates the degree of gaze concentration of the user on the shopping mall web page based on one or more of the gaze tracking information and the gaze analysis information.

10: The system of claim 9, wherein the data analysis module acquires user-related information comprising one or more of a user's age and a user's gender, and calculates an average degree of gaze concentration of one or more of the user's age and user's gender for each web page based on the user-related information and the gaze analysis information.

11: The system of claim 9, wherein the data analysis module extracts a purchase decision factor of a user who purchases a product through the shopping mall web page based on gaze-related information of the corresponding user.

12: The system of claim 11, wherein the data analysis module checks the degree of gaze concentration of the user by each region constituting a web page of the product purchased by the user in the web page, and extracts a purchase decision factor of a user according to the degree of gaze concentration among regions constituting the web page.

13: The system of claim 12, wherein the shopping mall web server further comprises a user-customized module that changes one or more of an order and arrangement of respective regions of a web page to be provided to a corresponding user terminal according to the purchase decision factor of the user.

14: The system of claim 9, wherein the data analysis module calculates a purchase route pattern that comprises one or more of the order of the web pages viewed by the user, a direction of the user's gaze flow within each web page, and a degree of gaze concentration for each region of each web page based on gaze-related information of the user who purchased the product through the shopping mall web page.

15: The system of claim 9, wherein the data analysis module selects one or more of a product of interest, price range of interest, preferred color, and preferred brand of the user based on product-related information of products related to web pages whose degrees of gaze concentration is equal to or greater than a preset degree of gaze concentration among web pages viewed by the user based on the gaze-related information of the user.

16: The system of claim 15, wherein the shopping mall web server further comprises a user-customized module that extracts information about the previously stored product of interest, price range of interest, preferred color, and preferred brand of the corresponding user when being accessed by the user terminal, and recommends a product corresponding to the extracted information to the user.

17: A method for shopping mall gaze analysis which is a method performed in a computing device comprising one or more processors and a memory storing one or more programs executed by the one or more processors, the method for shopping mall gaze analysis comprising:
providing a shopping mall web page to a user terminal;
receiving one or more of gaze tracking information and gaze analysis information from the user terminal; and
analyzing a degree of gaze concentration of the user on the shopping mall web page based on one or more of the gaze tracking information and the gaze analysis information.
